(19) United States
(12) Patent Application Publication
(10) Pub. No.: US 2012/0079963 A1
(43) Pub. Date: Apr. 5, 2012

(54) Briefcase Workstation

(76) Inventor: Matthew Ballard Herschler, Shutesbury, MA (US)

(21) Appl. No.: 12/844,819

(22) Filed: Jul. 27, 2010

Related U.S. Application Data
(60) Provisional application No. 61/271,858, filed on Jul. 27, 2009.

(51) Int. Cl. A47B 85/06; F16B 21/00

(52) U.S. Cl. 108/14; 403/325

(57) ABSTRACT

Said briefcase workstation is an extremely portable and workstation of remarkable stability in which the seat and table sections being the compartments and come together to make its own carrying case. Even as a briefcase there is room inside said case not just for the hardware required for assembly, but also for work related materials, medical equipment, laptop computer, or other technology, biological equipment, notebooks, journals, art and calligraphy supplies, for fly tying equipment and or lunch.

This application claims the benefit of 61/271,858

### BACKGROUND AND OBJECT OF INVENTION

Portability means many things to many people, but to the traveler it means things you can carry comfortably, not lug around. Portability to the traveler also means ease of use. Something can be easily portable but if it is awkward or difficult to assemble, though charming in its novelty, to the traveler it is not especially useful. It also excellent if it is reliable as it is nice on the road with so much that is uncertain that something can be depended on. The object of this invention was to make a workspace suited to the traveler, a work space that was as easily carried as possible, that was as stable as possible, that was light as possible, that was simple to assemble as possible, and of such size and weight that it would not preclude the simultaneous carrying of some necessities and work related materials.

### HISTORY OF INVENTION

Simply, while there is a long history of folding chairs and folding tables, and folding combinations of chairs and tables, a long history of portable desks, most of these without chairs, and a shorter history of portable workstations, there is no history of a chair and a table where the two are the compartments that come together to make a case.

### SUMMARY OF INVENTION

A BRIEFCASE WORKSTATION is a portable brief case or bigger that comes apart to make a seat and table. In addition to holding the hardware required for such conversion, A BRIEFCASE has room inside it for other work related materials. As a workstation said BRIEFCASE WORKSTATION is also remarkably stable. Applications for such a case are as diverse as the people might use them. All manner of professional uses are possible. For medicine, for science, professionals of all kinds, any sort of field use, and certainly for travelers. From military applications, to stream side fly tying stations, or watercolor and calligraphy in the highlands, such case makes a comfortable work space anywhere you bring it, and its portable enough to bring most anywhere.

Though conceived as a travelers case, its stability and compact-ability make it also attractive for use where space is at a premium, for schools and churches and community centers, and even for families who want to be able to convert their living spaces to a variety of purposes. Also, though conceived as a brief case, its size is not limited to that.

There are many and excellent embodiments of said workstation possible, many materials with which to make the case, many mechanisms by which legs can fold or unfold, or attach and detach, many hardware solutions to allows the swiveling of the rear table legs, or their fixing in position, many alternate and remarkable embodiments that adhere to its basic principles.

The following disclosure can only begin to touch on them.

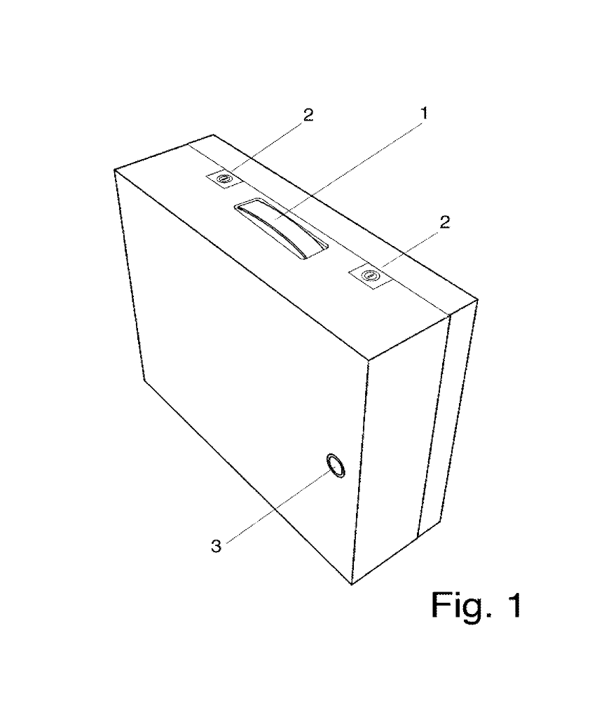

FIG. 1: briefcase workstation as briefcase

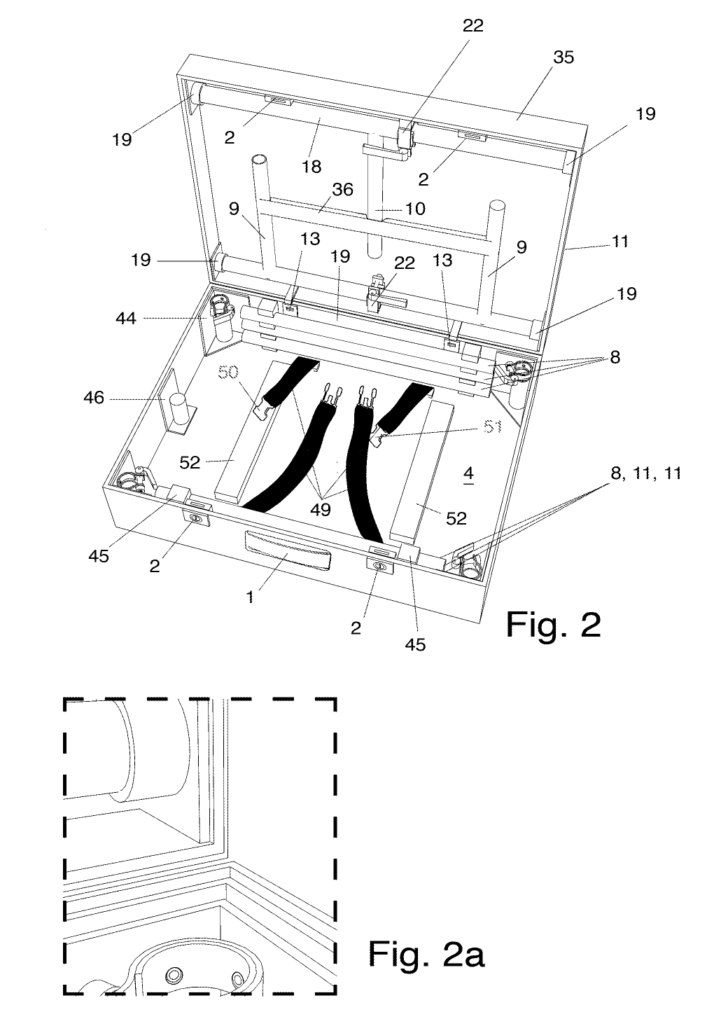

FIG. 2: Briefcase open

FIG. 2a: Detail of case fitting

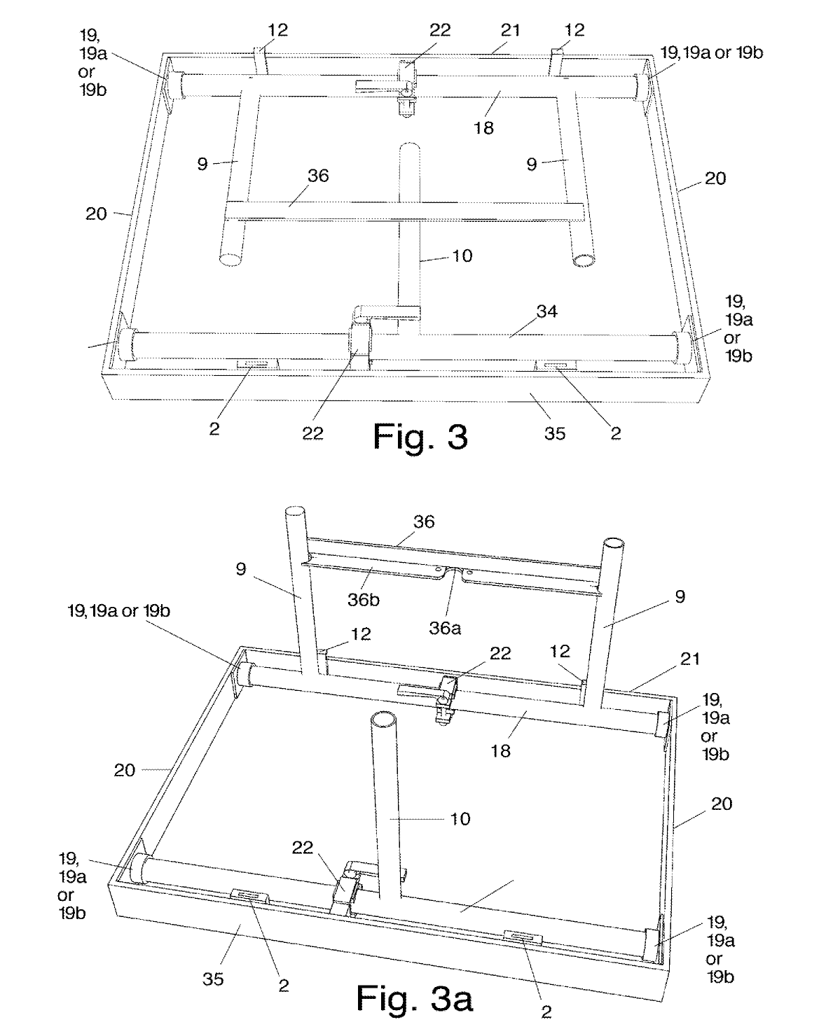

FIG. 3: table compartment

FIG. 3a: table compartment with legs swiveled

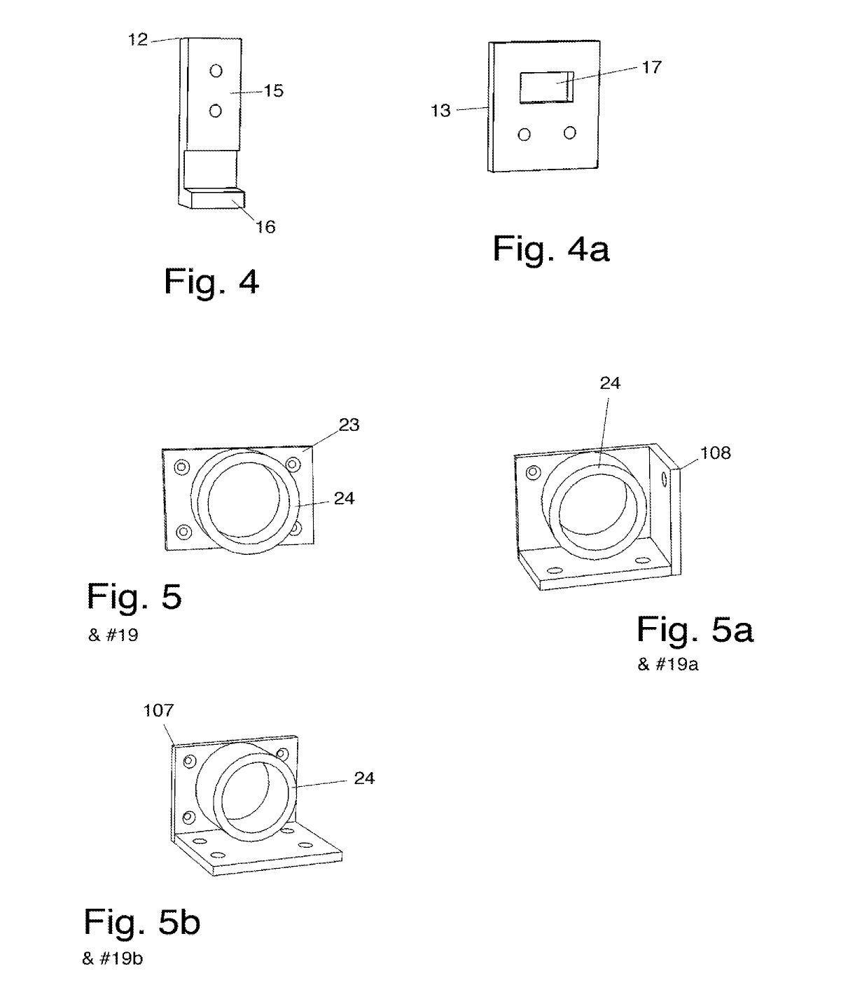

FIG. 4: case hook

FIG. 4a: case hook catch

FIG. 5: connector pipe swivel housing

FIG. 5a: swivel pipe end with 3 sided bracket (the corner is adjustable)

FIG. 5b: swivel pipe with 2 sided bracket

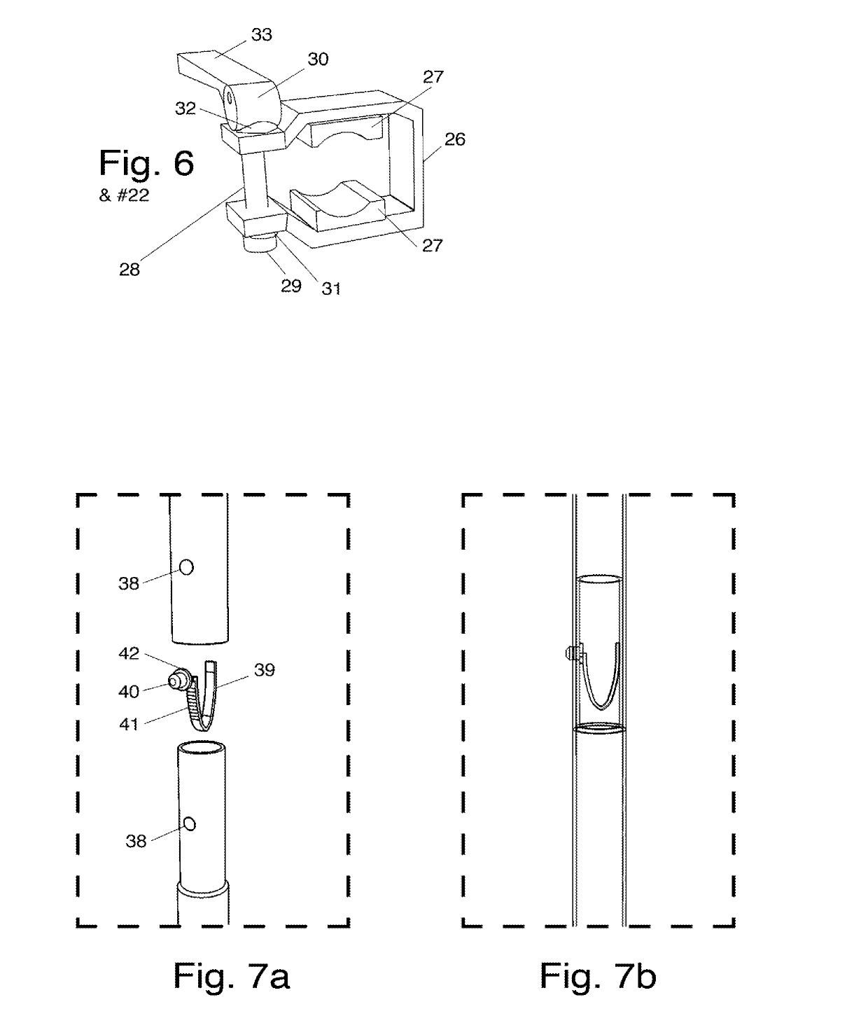

FIG. 6: cam grip

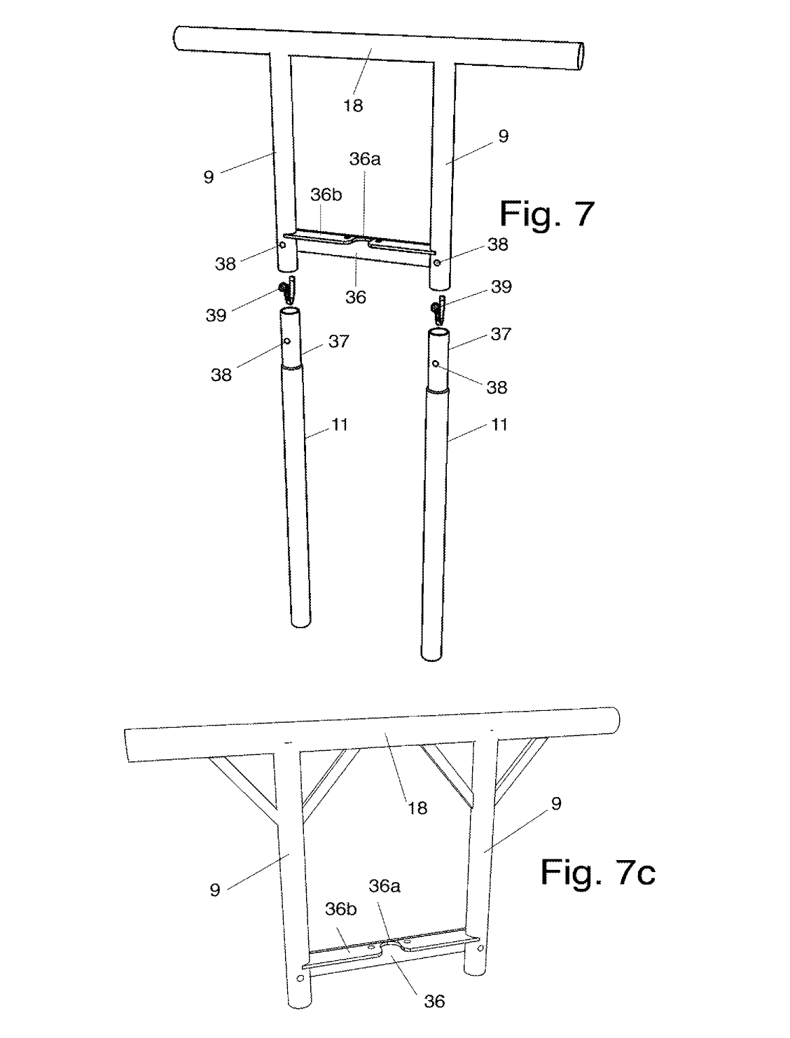

FIG. 7: exploded view of rear leg assembly with extensions

FIG. 7a: internal pipe spring button catch

FIG. 7b: internal pipe spring button catch transparent

FIG. 7c: rear table leg and connector pipe unit reinforced

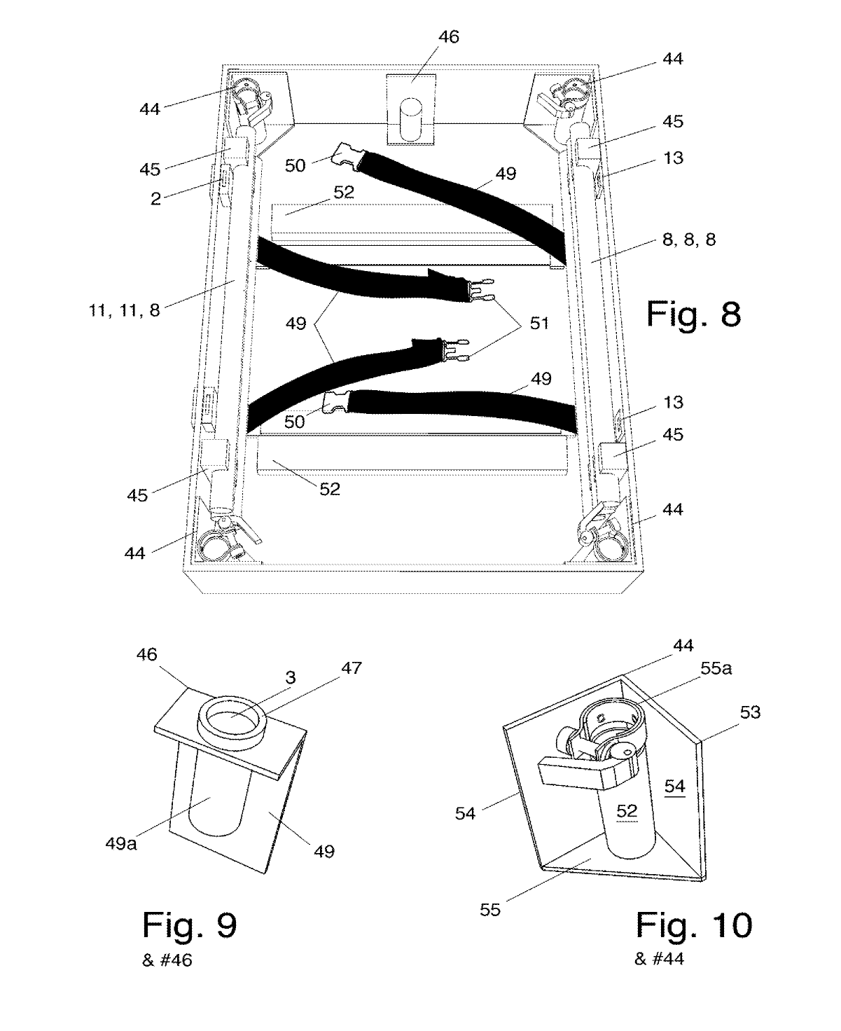

FIG. 8: seat compartment

FIG. 9: pedestal support

FIG. 10: cam grip leg receptacle

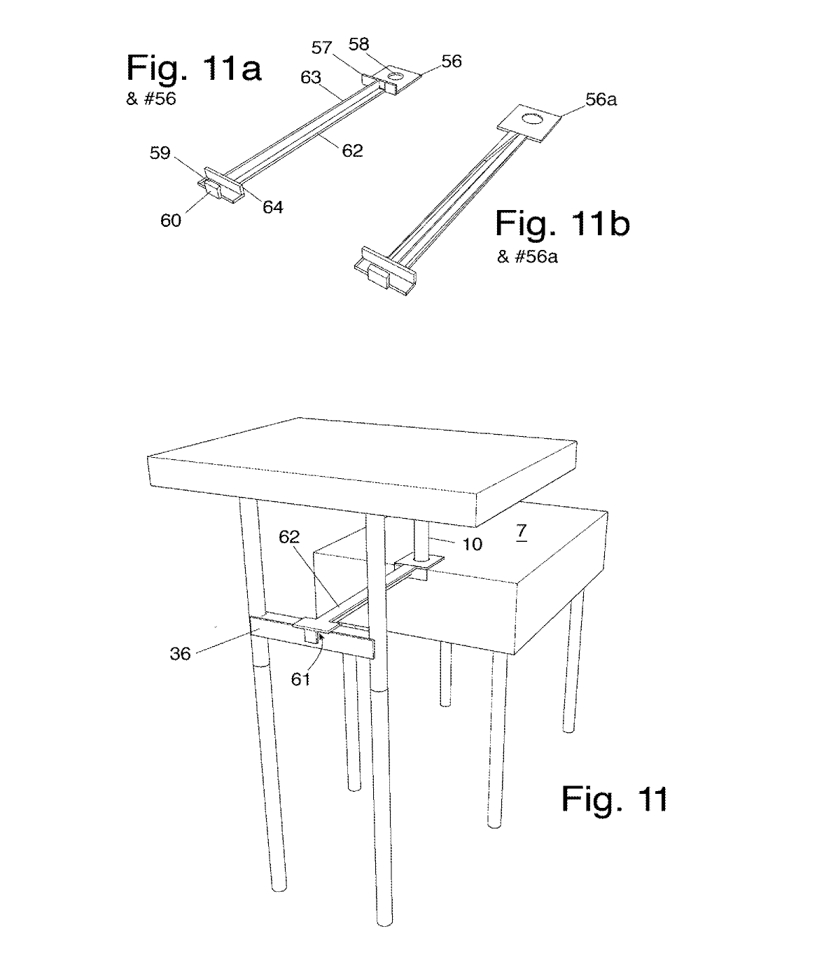

FIG. 11: Assembled workstation with straddle support

FIG. 11a: straddle support

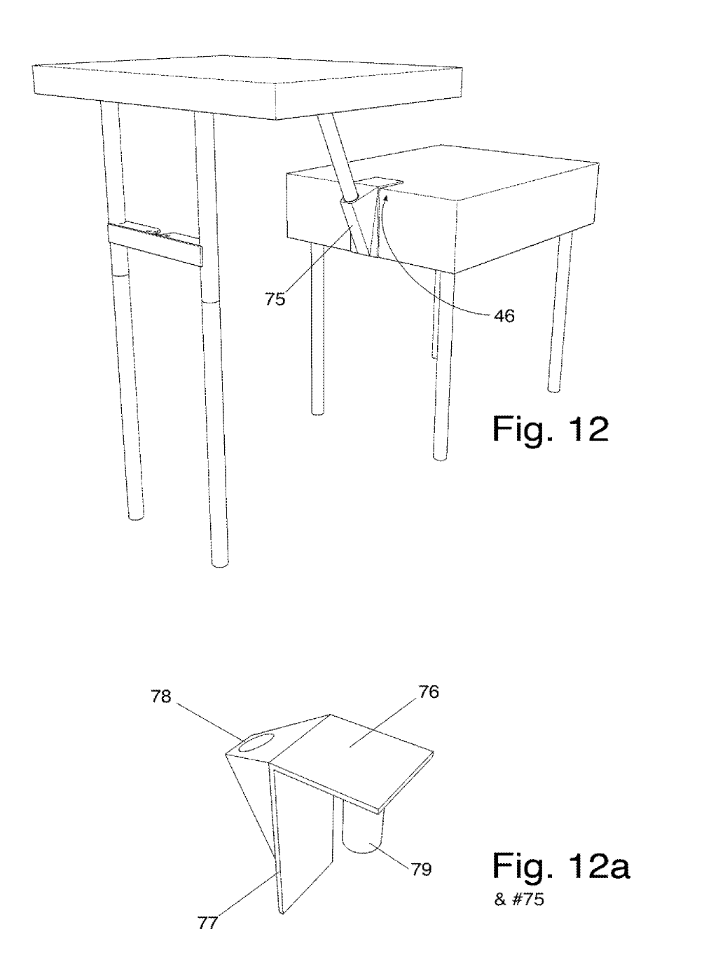

FIG. 12: Assembled workstation with pedestal extender nose

FIG. 12a: pedestal nose extender

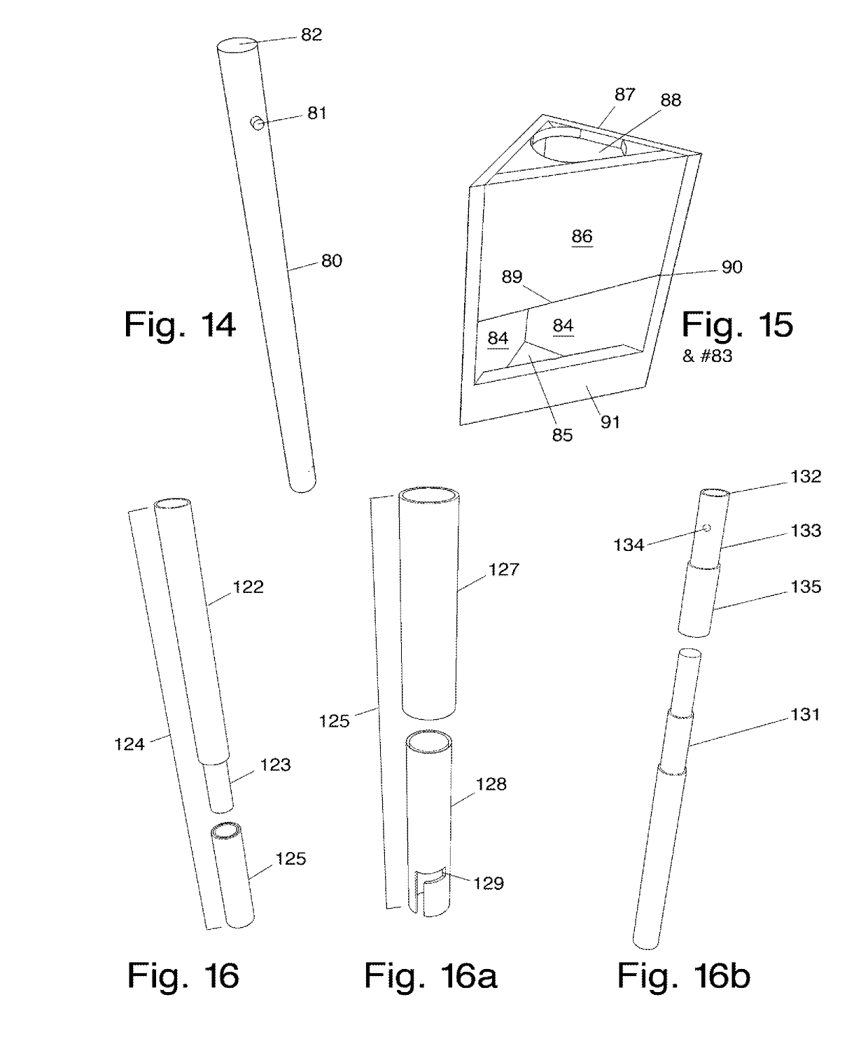

FIG. 14: single pegged twist lock leg

FIG. 15: twist lock leg receptacle

FIG. 16 twist lock rear leg

FIG. 16a: twist lock connector housing

FIG. 16b: twist lock extension leg

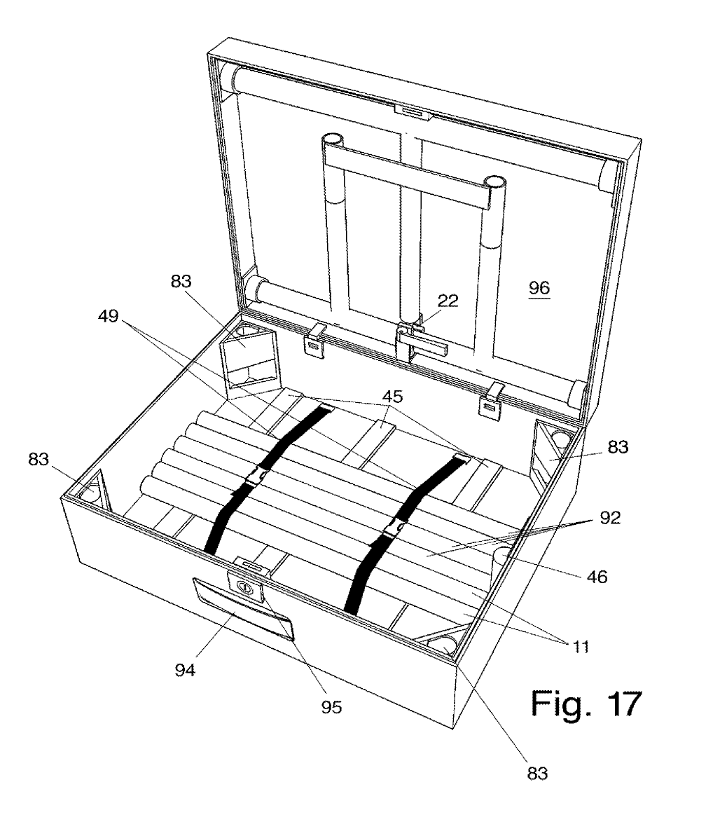

FIG. 17: a smaller suitcase workstation

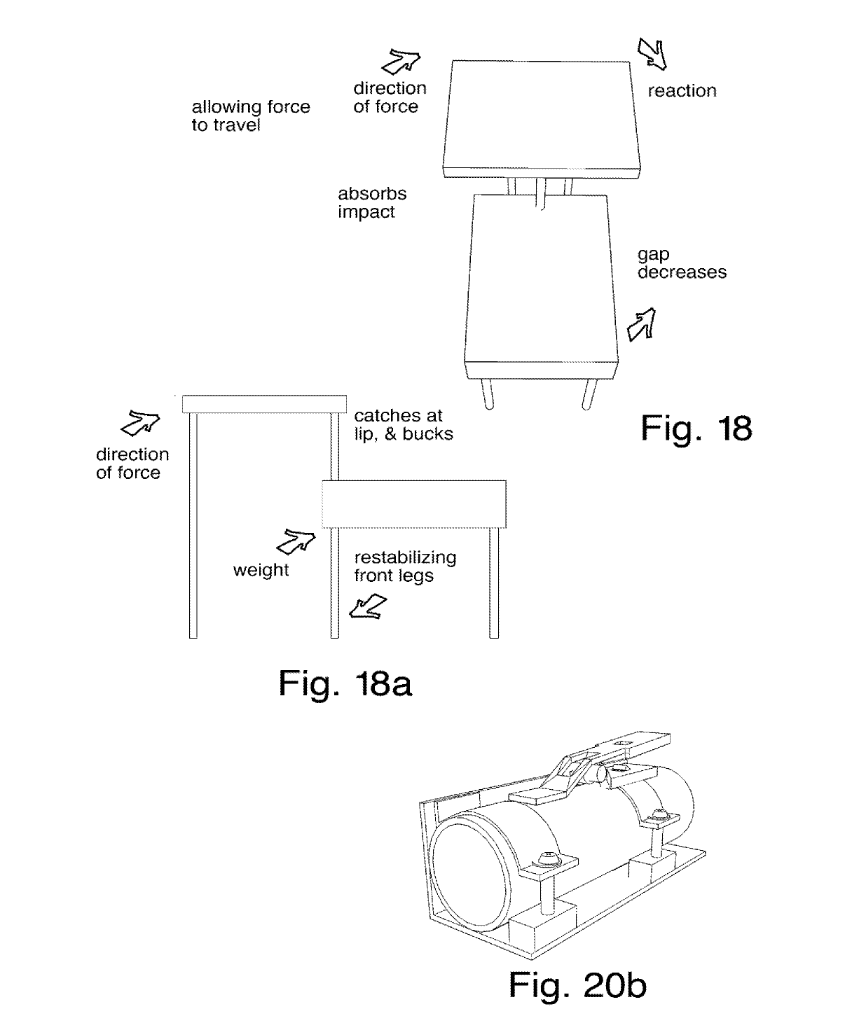

FIG. 18: horizontal flexibility

FIG. 18a vertical flexibility

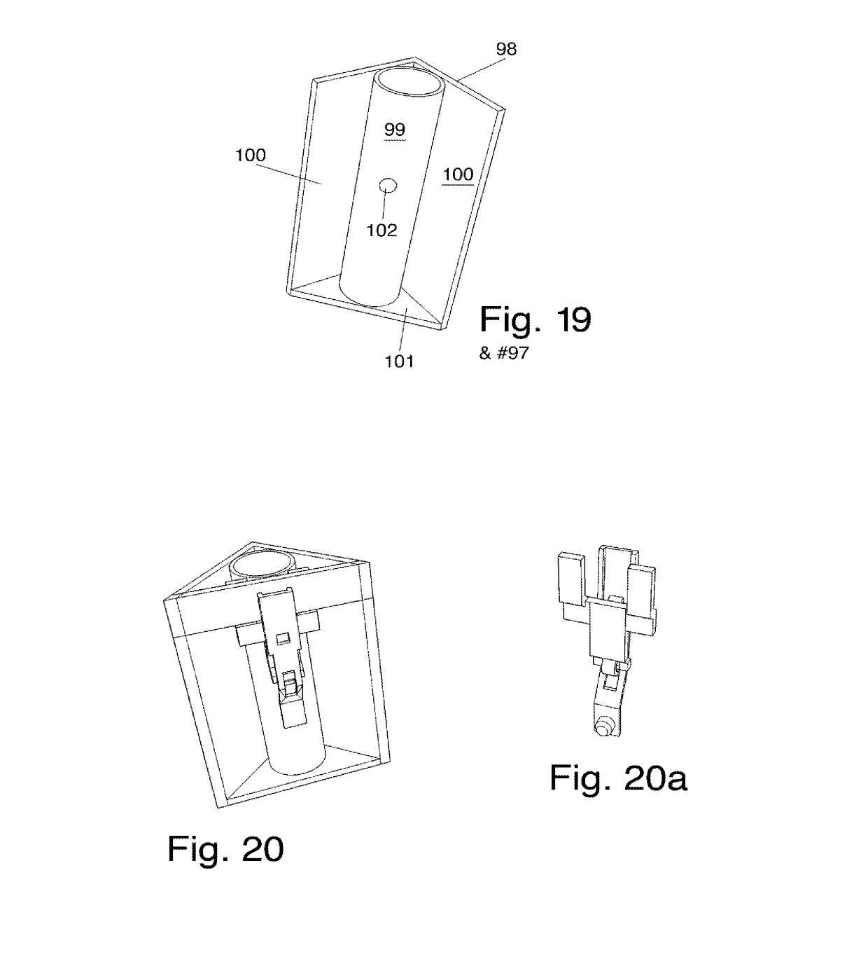

FIG. 19: spring button lock leg receptacle

FIG. 20 external spring clip leg housing

FIG. 20a: leg housing spring clip detail

FIG. 20b external spring clip applied to connector pipe

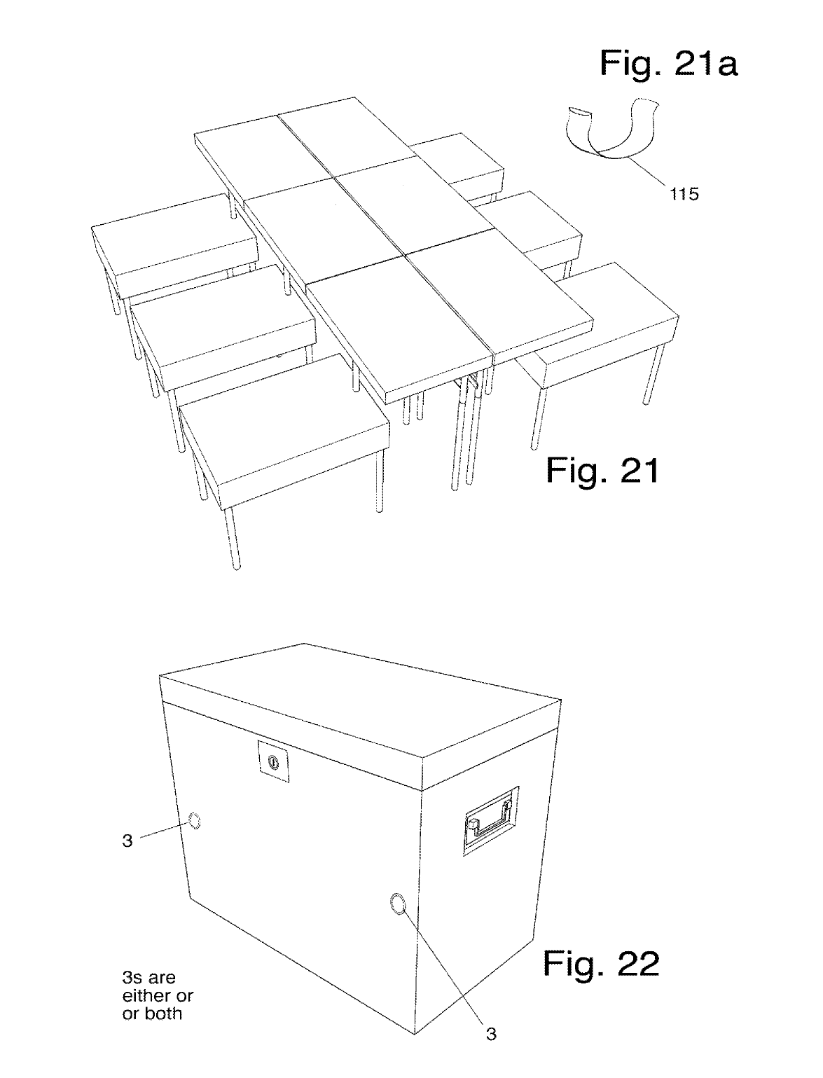

FIG. 21: six workstations together

FIG. 22: Trunk style workstation.

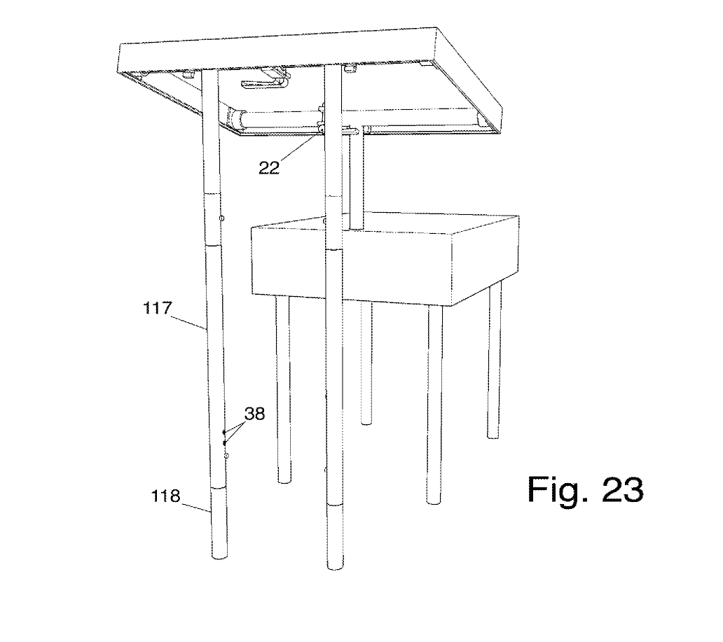

FIG. 23: workstation easel.

### DETAILED DESCRIPTION OF INVENTION

### Overview

Basically, the WORKSTATION is a case in two sections, a seat section and a table section. These sections come apart to form the table and seat. There are four seat legs. These are detachable and store in the seat section. There are two rear table legs. These are connected and swivel out from the back of the table. There is also a front table leg here termed pedestal support which the sitter straddles when sitting. This pedestal support also swivels out from the table compartment where it is stored. Two table leg extensions attach to these said rear table legs, so making the length together to support the back of the table. These leg extensions also store in said seat compartment. In addition to such leg hardware, there is mechanism to connect to two halves of the case and to lock it, means of storing detachable legs, of keeping materials in seat section when it is inverted, and finally means to carry it.

FIG. 1 shows the briefcase workstation as a briefcase with a handle (1) two locking button release latches (2) and a pedestal hole (3). In FIG. 2 this case is show open. Its two compartments, the seat compartment (4) and the table compartment (5), make up the two halves of the case and detach from each other so that the backs of said compartments can make the table top (6) and seat (7). While separating hinges would suffice for such purposes, this embodiment shows case hooks (12) mounted to the back of the table compartment (5) that meet case hook catches (13) set in the back side (14) of the seat section. This has the advantage making the hardware invisible from the outside of the case. Shown in FIG. 4, the case hook (12) is very simply an L shaped metal strip bent slightly wide. The long side of the L (15) is attached to the back side of the seat compartment (14), with the short side of said L (16) overreaching the top edge of said back side and out over the case side. The case hook catch (13) is a simple flat with a slot in it to receive said case hook (16). Said case hook (12) is positioned on the back side (14) of the table compartment so that when the back of the table compartment is brought together with the back of the seat compartment, they are aligned. Once so aligned, the front of said cases are brought together, with the two hooks (12) in the table section slip into the case hook catches (13). When these are properly set, such is a very snug and satisfying fit. Again, separating hinges, though on the outside of the case, are common and satisfactory to such purposes.

### The Table Compartment: FIG. 3

Installed into the table compartment (5) are three pipe legs. Two of these legs are back rear table legs (9) are connected by means of a rear leg connector pipe (18) that turns in two rear connector pipe housings (19) so that the legs can be swiveled between a stored and an upright position. These connector pipe housings (19) are mounted to the right and left side walls (20) at the back of the table compartment (21). Again, the rear leg connector pipe swivels so that the rear legs may be moved between in horizontal stored and perpendicular functional positions. A cam grip (22) works to hold the back rear table legs in a stored or upright position.

FIG. 5 shows a pipe end housing (19) consisting of a pipe end cup (23) in which the connector pipe ( ) fits very closely without chafing. Said pipe cup (23) is fixed to a mounting bracket or plate (24). The rear table leg connector pipe (18) is capped by connector pipe housings (19) on each end, and as such unit is installed into the side walls (20) of the seat compartment (4) snug to the back side (21).

Given the amount of stresses focused on the joint between the connector pipe housing ( ) and the seat compartment( ), and the huge diversity of materials of manufacture FIG. 5a, 5b, concern modifications of the connector pipe end housing bracket.

FIG. 5a shows the pipe cup (24) fixed to am L bracket (107). Said L bracket is meant to connect to both side walls (11) and the back wall (12) or to the bottom and side wall (11) of the table compartment (5). FIG. 5b shows the pipe cup mounted to a three-sided bracket (108), providing contact and opportunity for connection to the side wall (11), the back wall (12), and the bottom of said table case (5). Recessed screw holes (109) are shown but means of attachment can be various given the requirements of various case and hardware materials The three sided bracket (108), like the two sided bracket (107) and the plate bracket (23) may be of any dimension that fits the case so affording where necessary more contact surface to improve hardware to case connections

Important to say here regarding absolutely all situations where hardware must be attached to the case, the means of fixing such to said case are several and diverse and depend on tools and technology available and material involved. Riveting, gluing, welding or casting as one piece come to mind. Where injection or rotational molding is used, metal inserts can be placed in the molded material and metal screwed into. Where such concern for strength and reliability exists, such hardware via their brackets can be mounted through the case to backing plates outside the case. Such backing plates are so completely securing that they tend to transfer the stress to the case. Note here that the case also can for both esthetic reasons and reinforcement may have a shell attached again in some number of ways or a protective covering applied, or for that matter both. In deed all interior hardware might be installed into a harness fitting the case and so working to disperse stresses with firm connection on the case material.

### Note on Alternatives to Pipe Legs:

While in this embodiment pipes are used in the table compartment, there is no requirement that the legs and connecting members be hollow. It is only the limited availability of materials that makes it so. Square hollow legs or even solid legs would also work excellently. Such alternate embodiments might in some cases require some hardware modification.

Also in the table compartment shown in FIG. 3, 3a is a rear table leg cam grip (22). Said grip is attached to the case embracing the back leg connector pipe (18) near the midpoint.

Such cam style locks are common in quick release applications like bicycle wheel attachment, or for seats and handle bar adjustments also on bicycles. As such basic technology is very reliable, and quick to release it is well suited for use with the BRIEFCASE WORKSTATION.

Detailed in FIG. 6, the rear table leg cam grip (22) is made up of a bracket (26) that circles the swivel bar on 3 sides, and mounts to the table case. In this embodiment said cam lock is mounted so that the cam lock bolt is to the side of the rear leg connector pipe (18). This cam lock has a cam bracket (26), gripping surfaces (27), a double threaded bolt (28) that works in conjunction with an adjustable end nut (29) and the cam lever nut (30) to set the angle and intensity of function. A lock washer (31) on the adjusting nut ends and a rubber washer (32) on the cam lever side set the adjustment. When the cam lever (33) is lifted the gripping surfaces release the connector pipe. When said cam lever is again lowered the gripping surfaces fix the connector pipe.

Note: in bicycle applications, the gripping surface is metallic and takes the full shape of the pipe. Given the variability of material, and the kind of use intended for the BRIEFCASE WORKSTATION, field use for example, two such cam style grips, one at each end of said connector pipe (18), may be both more stable and reassuring.

In this embodiment a single cam grip (22) is set near midpoint between connector pipe ends (18). Said cam grip (22) works to set rear table legs (9) in perpendicular or stored position. FIG. 3a shows the table compartment with the legs fixed for use.

### Front Pedestal Support

Again referring to FIG. 3,3a, the front leg of the table also called pedestal support (10) extends from the center of the pedestal connector pipe (34). While this leg might be doubled and spaced for more stability, importantly, whatever their width, they are straddled. In this embodiment front pedestal support is a single pipe extending perpendicular from the center of the center of pedestal connector pipe (34).

Like the rear table legs, said front pedestal connector pipe is capped by pipe end housings (19). These housings are fixed also onto the side (20) of the table compartment at the front (35) of the table case (5).

These pedestal pipe end housings (19) may be fixed exactly at the front side corners of the case so long there is room for case latch assemblies (2). Also to mention, there are advantages to the pedestal pipe past vertical, one being disassembly. Another disclosed further. In such case additional stresses may be placed at these joints. To meet such stresses these front pedestal pipe housings may require specially adapted bracketing. FIG. 5b is once such modification. FIG. 5c shows another.

A second cam grip (22) is mounted at the front near center of the table compartment (5) so as to fix said pedestal support (10) by means of its connector pipe (34) in open and closed position. set near the center of said pedestal connector pipe but not on center as such would interfere with operation is a cam grip (22). As said pedestal pipe connector may be further from the front of the table case than the back connector pipe is from the back of the case, and as the firm mounting of said cam grip on both the back of the table compartment and the is essential to reliability, and again given the wide range of materials of manufacture, a longer cam grip bracket may be necessary.

NOTE: if a gripping surface need be held to the bracket in only one, the corner of the case tends to be strongest.

FIG. 7 shows the rear table legs (9) connector pipe (18) unit with a rear table leg cross member (36) set between the two legs near their extreme. While said cross member can be flat, or T or L shaped for added resilience. Importantly where there is a back bar 36b, there is a gap (36a) at the center of such cross member (36) to allow for the pedestal support. Referring to FIGS. 3 and 3a, when legs are returned to the case, said pedestal support (10) is first. Rear table legs (9) follow. The cam grip (22) on the rear table leg connector pipe by fixing the said rear table legs (9) also fixes the pedestal support (10).

NOTE: In closed flush position the cross member holds the pedestal support (10) and there is no need to clamp it. Also, with pedestal (10) in vertical, these pipe end housings (19) are under considerably less potential stress than the back pipe end housings. As such, in lighter duty applications, or where cost is a consideration, the front cam grip may be considered optional.

Connecting to the rear table legs (9) are two detachable extension legs (11). Again FIG. 7, 7a, 7b work together to illustrate. Each of said extension legs is of a diameter identical with the rear table leg with the exception that at the end where it inserts into said rear table leg. Here said extension leg (11) is of reduced diameter, this reduced segment here termed the head of the leg (37). These legs can be simply snug fitted together, but in this embodiment, to ever more surely fix the legs together there are pipe holes (38) in both the head (37) of the extension leg and in the rear table leg (9) near its extreme to accommodate a button spring catch (39) works to connect them. Holes are placed

The spring button catch itself (39) is comprised of a catch button (40) and a spring (41). The catch button has a lip around the base (42). When said spring button catch (39) is inserted into said extension pipe (11) so that said catch button (40) protrudes from the pipe hole (38), said spring works to keep said catch button pressed out of its pipe hole (38) and said lip (42) works to retain it.

With the spring button catch (39) so placed, depression of the spring button (40) allows the extension leg to be inserted into the rear table leg. Full insertion of the head and possibly some twisting allows the spring button head to find its sistered pipe hole (38) in the rear table leg. Said button catch has a rounded head (43) to ease assemble

Note: this is very common technology, one version of such described in Thomas U.S. Pat. No. 3,947,140 is for pipe extensions though I have not seen it applied to leg attachment.

### More Specifically the Seat Compartment, FIG. 8.

Inside the seat compartment (4) and referring to FIG. 8 there are 4 leg receptacles (44), one set in each of the four interior corners of the case. These leg receptacles are set to hold the legs vertically out of the case so that when seat legs (44) are fixed in them flipping said seat compartment (4) transforms it into a seat (7). These same four legs (44) when detached from the leg receptacles are stored on the sidewalls of the case in foam retainers (45) fixed to the side walls. There is room for 6 legs on the sidewalls, 3 on each side.

NOTE: A vertical spring clip to hold said legs would allow retrieval of the legs without disturbing the other contents, which in some cases might be useful.

Also in the seat compartment is the pedestal housing (46). Detailed in FIG. 9, said pedestal housing is fixed against the bottom of the case and said sidewall at the middle of said sidewall. There is a hole in the seat compartment (4) to allow for the rim (47) of the pedestal cup (48). Said pedestal cup is open through the bottom of the case, the rim of which shows in FIG. 1, but closed on the seat compartment side. The hole (3) in the pedestal cup (49a) is shaped to accommodate the pedestal support of the table compartment. The pedestal cup (49) is fixed to a pedestal bracket (49) that faces the both the bottom and the sidewall of the case. For added strength depending on materials an external face plate for which said bracket to attach may be desirable.

Returning to FIG. 8, at the rear of the case are two case hook catches (13) as described fixed at the top edge and space so as to align with case hooks installed in the table compartment (5). At the front of the case fixed to the top edge are two latches (2) also aligned with their sister latches in the table compartment.

Also in the case compartment (4) are two sets of straps (49), fixed to the floor of the seat compartment to hold whatever equipment might be stored there. Said straps (49) are fixed across from each other at opposite sides of the case along the front and back walls of said case. One side loose is fixed with a female strap catch (50), the opposite loose has its male counterpart (51), which inserts into said female and locks. After locking, the loose running from said male counterpart can pulled to cinch the straps around whatever material is stored there. There is foam on the bottom of the case in two strips (52) to keep materials from scuffling during transport. It is also possible to fix the legs by this manner should it prove convenient or the full width of the case be desirable to store some particular object.

FIG. 10 details cam grip let receptacle (44) installed into the four corners of the seat compartment. Each said receptacle has a leg pipe housing (52) set securely into a 3 sided bracket (53), with the pipe section laid between the two sides (54), and the bottom plate (55) closing the pipe. At the top of the leg pipe is a cam grip (55a) much like #22 detailed in FIG. 6. Again such hardware is common, though its use in detachable legs is not in to my knowledge documented.

In this embodiment cam grip leg receptacle is preferred because it is adjustable. This to say that a person while sitting can reach under the case and loosen a particular leg and re set it when the ground is uneven.

The leg for such mechanism is simple and straight and needs no addition or alteration, though at one end a cap is inserted to keep such leg from slipping or scratching floors.

### Remaking the Case: (FIG. 2, 1)

With legs inserted the seat compartment (4) is flipped to make a seat (7). The pedestal support (10) is then fitted into the hole (3) at the front of the seat and so the pedestal support housing (46), and fixed by reaching under the table to set the front cam grip (22a). When work is done, the four seat legs (8) are removed from their respective leg blocks (13), the two desk leg extensions (11) are removed from their back rear table legs (9) and settled into foam (45) fixed to the side walls of the seat compartment (4). At such time the other equipment work materials may be packed into the seat compartment and strapped in. With all materials returned to said case and cinched, the table compartment (5) is fitted to the back of the case so that case rims and case hooks (12) align to their case hook catches. Seat case rims and their sisters in the table compartment are detailed in FIG. 2a. So aligned, the fronts of the two cases can be brought together. Gentle pressure works to secure the latches (2) on the front side of the case. Said latches in combination with said hooks (12) work to fix the table and seat together, remaking the case.

To facilitate transport in this embodiment, a recessed handle (3) is attached on the latch side of the case between said latches. As a case said work station is easily transported, it is efficiently storable, even stackable, even fitting together with other said briefcase work stations like so many identical blocks. As such it well suited to spaces that require conversion from classrooms to activity spaces.

### Table Leg Reinforcement

### Cross Bars and Triangulation Between the Two Legs

As it is important that the rear table leg and their connector pipe are solid and reliable, and given the wide variety of materials used in manufacture and their diverse strengths and weaknesses, FIG. 7c shows braces triangulating said rear legs (9) and said connector pipe (18).

### Stabilizer

FIG. 11, 11a illustrate the used of an adjunct central stabilizer (56) that is fitted to the seat (7) at one end and to the table leg cross member (36) at the other. At the seat unit it has a front edge (57) to keep it from sideways motion. It also reaches over the top of the case and has a hole (58) that the pedestal support slips through on its way to the pedestal support housing. The other end said central stabilizer slips (56) over the top of the cross member (36) at the middle and then down to clip onto said cross member. A clip (59) at the base of overhang (60) meets a bulge or an indent (61) centered on the outside of the cross member (36). Said bulge or indent is visible in FIG. 3. The length of the central stabilizer is T'd with a flat top (62) and a central vertical rib (63) running the length underneath. This said vertical rib T's with a front rib (64). Set at a distance to accommodate the flat bar and its reinforcement, so stiffening the joint. FIG. 11b shows a central stabilizer that is identical with the one exception that it lacks a front edge (57) in FIG. 11a. As such said central stabilizer (56a) does not interfere with the shock absorption capacity of the seat to pedestal connection.

Importantly, while it is traditional to have entirely fixed hardware solutions, allowing for force to travel through an object so helping to dimansh that force is also reasonable proposition. This said, this connection could be rubberized, or in some other way made softer to absorb impacts.

NOTE: The central stabilizer works to lock the table directly in front of the seat, making the fixing of the pedestal support in the pedestal housing redundant. It is my experience that such fixing is not required in the said briefcase work station. The table is very at hand, and the legs are between the sitters feet. Should fixing be desired, a spring button catch inserted into the pedestal support (10) could find a hole in the pedestal support housing (46) facing front. Such housing could be placed close enough to the edge to allow a finger pressing to release it, or it could have a key, a button of a particular depth pressed into a button hole in the front of the case to release the pedestal, or a spring flap attached to the front of the case and held closed but a spring or catch of some kind, on a hinge. Opening said flap allowing the spring button in the pedestal support to enter said housing. Important to mention, the said briefcase workstation is quite remarkably stable as the swiveling connection between the table and the seat actually works to stabilize it. With a sitter it is enormously stable. With no one occupying the seat or table it can be kicked around a bit and still find its feet. This is because kicking the table legs to any side is kicking them toward the rear table legs. In addition the central weight is where the pedestal and table come together, and for the table and set legs to approach each other, the central weight must counter their motion.!!!

NOTE: when the journey case is unoccupied, as flexibility at the pedestal support greatly enhances stability the stabilizer ( ) may be disconnected at the rear table leg cross member and pulled off center to return horizontal flexibility to the pedestal support.

### Pedestal Nose

For larger people who wish to sit further from the table, FIG. 12 shows the BRIEFCASE WORKSTATION with a nose adjunct (75) that fits into the pedestal housing in the case and over the front of the seat flush to the side. Referring to FIG. 12a where the nose adjunct fits over the top of the case and into the pedestal support housing (46) is called the mount (76). Where it fits over It the front of the case it is called the drop (77). Fixed to said drop is a pedestal cup (78) which is positioned so as to hold the pedestal support (10) at an angle directly forward pushing the table (6) also forward and away from the seat (7). The pedestal connector pipe cam grip works from under the table to set the angle of the pedestal support and help to stabilize the angle of the pedestal support at the table compartment.

### Preface to Leg Attachment

Detachable legs have not been well developed in modern technology, as such, means for such attachment was not evident and required invention. Three alternate means of attachment and detachment are offered here.

Twist lock attachment is a very satisfying means of connection as it requires no finger manipulation, just a simple grip and twist of the wrist. Twist lock attachment can be well applied to both leg reception in the seat case, and also to leg extension. One particular method of twist lock is here offered as solution and detailed in FIGS. 14, 15,16, 16a 16b, 16c.

FIG. 14 shows a twist lock style leg (80). Peg (81) is set a short distance from the top (82) of said leg on one side. Such peg (81) extends perpendicularly from the center of said leg a short distance and only long enough to assure operation which is described below.

FIG. 15 shows a remarkably simple receptacle for such a leg. FIGS. 14 and 15 together help to explain operation. The twist lock leg receptacle (83) consists of a three-sided corner bracket described in several embodiments above with two side plates (84) and a bottom plate (85). A front plate (86) connects the two side plates at a 45 degree angle. The top (87) of the leg receptacle is open at the center to allow the insertion of said leg, with said front plate (86) and said two side plates (84) positioned so said three plates together make the space between them to exactly suit the diameter of said leg (80). The top of the leg receptacle (87) is also open on the right side (88) to accommodate the peg (81) on the leg (80). This works to show the user which way to insert the leg. It also works to reinforce the leg receptacle against deformation. The bottom edge (89) of the face plate (86) is angled with the right side reaching about midway (90) along the edge of the side wall (84), and the left side of said face plate reaching further down its adjacent side plate. This is so that when the leg (80) is very near fully inserted into its leg receptacle (83), the turning of said leg clockwise works to fix said leg inside said leg receptacle. A last plate, a knee plate (91) is attached to the bottom plate (85) and a short distance along both side walls (84). This knee plate (91) works to assure that the leg top (82) is firmly positioned also against the two side walls (84). Such knee plate (91) also works to assure the structure of the leg receptacle (83). Finally some softening of components edges, especially around the leg top (82), where it enters the leg receptacle (83), and even where it passes the knee plate (91) may ease operation.

Twist lock technology is attractive because it is so snug fitting, simple and handed, not fingered. As such it can be applied to connecting table legs and their extensions. FIGS. 16, 16a, and 16b detail such technology intended for solid leg members. FIG. 16 is an exploded view of the leg member (122) and the twist lock connector housing (123) that come together to form the rear table leg (124). In this particular embodiment said leg member (122) is of reduced diameter where it enters the top (126) of side of the connector housing (123). Importantly this reduced diameter said leg member ( ) from entering said connector housing (123) more than half way. how the leg member and the extension housing are connected depends on materials. In wood and metal, as this is originally conceived for, a single rivet might serve, or spaced cross rivets, or a series of small short spikes driven through the extension receptacle ( ) into the leg, with such spikes welded into the surface and polished smooth.

FIG. 16a is an exploded view of said connector housing (125) consisting of an outer pipe (127) and an inner pipe (128). The outer pipe is simple and smooth. Said inner pipe also has an absence (129). With said inner pipe (128) and said outer pipe (127) connected said absence (129) becomes a slot which works at accept and lock the extension leg via its peg. Said absence is shaped also so that once the inserting part of the leg has near reached its extent turning works to tighten it. FIG. 16b details the extension leg (130) showing it to be comprised of a leg body (131) and an sleeve (132). Said sleeve (132) sleeves said leg body (131) and being of similar component materials to the leg member and its connector housing is attached similarly. One difference is that the diameter of the leg body (131) is stepped down twice to accommodate the sleeve (132). This more gradual reduction in the diameter increases the potential strength of the connection as it represents an effort to minimize the materials of said adjunct to maximize the amount of the potentially weaker leg member material. Said adjunct (132) has a hollow leg top (133) with peg (134) connected to a pipe section of wider radius (135) which works to set the limit of entry into the connector housing. At its open end said sleeve (132) is of a diameter to flush with the extension leg body (131).

FIG. 17 shows a brief case embodiment of said briefcase workstation with the above detailed twist lock technology. This is a notably smaller case as seat legs (92), in the manner of (80), require the near full extend of the seat compartment (93) for storing. For such reason any means of holding legs to the sides of said seat compartment are eliminated. In this embodiment, the legs (92) are held by the cinch straps (49) and by foam strips (45), both set to the bottom of the seat compartment (93). Where more equipment is included, the legs may be placed again on bottom, or on top of such equipment. The seat compartment also has an unrecessed handle (94) so as not to interfere with a single central latch (95). Also different in this embodiment, the table compartment (96) it has only one cam grip component (22) applied to the rear leg connector pipe (93). Besides economy, such builds in also flexibility.

FIG. 18 helps to illustrate the horizontal flexibility built into this workstation and detailed earlier. With the pedestal support (10) set into the pedestal support housing (46) through the seat (7), when the seat is jarred, said seat can move from side to side with little disturbance to the table top position and materials that may be settled there. Arrows illustrate such possible motion.

FIG. 18a helps to describe the vertical flexibility available to all such workstations but built into this embodiment, with the pedestal support connector pipe (34) lose in its connection pipe housings (19) vertical flexibility or swivel between the table (6) and the seat (7) is won. Arrows illustrate the motion. When the workstation is unoccupied this doubled flexibility or swivel-ability works to better and more completely absorb impacts. Alternately, where the levelness of the table is concerned, keeping the pedestal support connector pipe (34) fixed by its cam grip (22a) may be desirable.

Spring button catch technology is common and widely known, and is a potentially universal solution for all situations requiring pipe fixing and release. FIG. 7, a, b regard rear table leg extensions (11) and are detailed above.

FIG. 19 shows spring button technology applied to a leg receptacle (97). Such leg receptacle (97) consists of a three-sided leg receptacle bracket (98) detailed in other leg receptacle disclosures. A pipe housing (99) is attached between the two side plates (100) adjacent to each. This pipe housing (99) is capped at one end by the bottom plate (101) and open at the top to receive a leg in the style of the extension legs (11). Such pipe housing (99) also has a hole (102) exposed to the outside open side of the leg receptacle (97) midish way between its ends. Such hole (102) is placed to receive the spring button (40) protruding from the spring button catch leg styled like extension leg (11).

External spring button catch technology is also widely known and a potentially universal solution for all situations requiring pipe fixing and release. FIG. 20 shows an external spring button catch styled leg receptacle (103). Such receptacle is virtually identical to the receptacle detailed in FIG. 19 with the exception that there is in addition a cross plate (104). Such cross plate (104) is attached to the leg pipe housing (99) at the on the side of said pipe housing at the top (105) and to both side plates (100) also at the top, not to interfere with the open end of said leg housing. An external spring button catch (106) is fixed to the cross plate (104) and detailed in FIG. 20a.

Such external spring button catch (106) consists of a handle (107) like the half of a clothes pin with a button (108) styled like (42) attached at the tip of lower end of said handle on the side that's hidden in use. Said handle (107) has a tongue (108) near its middle that hooks into a recess (109) at the lower extremity of the catch mount (110). Capping the recess (109) and so forming it is a small bar (110) that the tongue (108) in the handle (107) curls around. A spring (111) set between said handle (107) and the catch mount (110) works to separate the top end of the handle (112) from the top of the mount (113). Such spring (111) also works to hold the handle (107) and the mount (110) together and to press the button catch (108) into the hole (102) in the leg pipe housing (99). Finally, in this embodiment at the top of the mount there are two forks (109) set back from the regular mount surface the width of the cross plate material, and placed such that the assembled external spring button catch (106) may be slid as a unit into place along said up along the pipe housing (99) and under the cross plate where it clips in or is otherwise secured.

FIG. 20b shows the same spring button catch technology applied to double open ended pipe housings. The open ended external button catch functions similarly to the similarly styled leg receptacle ( ) but has a two sided bracket ( ). In this embodiment this two sided bracket ( ) is the length of the pipe housing. As such it offers a great deal more contact with the bottom and the sidewall of the table case. Should the reliability of the connection of the rear table legs to the case, said external spring catch mechanisms become doubly useful.

FIG. 21 shows a number of assembled work stations joined together to form a meeting table. While such tables may simply be positioned as such, where it is desired they may be connected by C clips (115) slipped over adjacent table sides from underneath the table tops (6). Where there is want for more leg room and or a completely flat surface as in impromptu conferences or steadying larger equipment of sharing food etc. . . . Also a large board or legless table top may be placed over a number assembled work stations and well supported by them. Such table top might be thin and light, and not completely rigid and still serve adequately given the support said assembled workstations afford it.

While we have been talking about traditional and brief case proportioned cases, so long as two parts of the case separate to form the table and seat section the essence of the invention is satisfied. To give just one case example FIG. 22 shows a simple trunk. The lid ( ) of such trunk separates to make a table, There is no need for seat legs as the compartment forms the seat. Also notice that the pedestal support ( ) on the side of said compartment and not as in previous embodiments on the bottom. This means that the compartment lies with the open side beside the sitter, making such equipment as is stored there easily available to the user. Such cases can be right handed, or left handed or, with two pedestals, ambidextrous. The impact such a simple concept might have on the future of portable furniture is inestimable.

Finally in this disclosure, it may be desirable to have a table top (6) whose angle is adjustable. There are a number of means to accomplish this. One solution is to lengthen the back legs. FIG. 23 shows the assembled workstation with rear table legs (9) and telescoping extension legs (117) in the style of extension legs (11) but with telescoping inserts (118) extending out the bottom of said extension legs. The length of said telescoping extensions legs (117) is adjustable by means of internal spring button catches ( ) described earlier.

As such there is a single hole (38) in the telescoping extension (121) that a button catch (40) of a spring button catch (39) protrudes from, and number of holes (38) in the extension leg itself corresponding to various height settings. By such means, lengthening of said extension legs (117) works to raise the back of the table top (6). Also important to such conversion, lengthening the telescoping extension legs (117) shifts the angle of the table (6) in relation to the seat (7) and so angle between of the pedestal support (10) in relation to said table. Given said circumstances, the pedestal connector pipe (18) requires either flexibility or cam grip (22) loosening and adjustment.

Such raising of the table top also changes the angle of the rear table legs pointing them out in the direction perpendicular to the table top (6). So positioned, the angle of the table legs work to give the assembled work station a charming stance as the two angled legs, no longer vertical, directly support any force applied directly against the table top (6). Where there is higher traffic the risk of such legs being kicked increases dramatically. As such it is recommended that they be returned to a vertical position beneath the table top by means of loosening and tightening the cam grip (22).

FURTHER REGARDING HARDWARE: In its basic configuration as specifications and claims will reveal, the briefcase workstation is unprecedented in portable furniture. Still, as to the details, there are a wide variety of means by which the legs might attach and detach, or swivel and latch, or connect or telescope. Legs might even be made to fold or swivel out of the case. As such this is not nor can it be a comprehensive presentation of alternate embodiments.

EXPANDED POLYMERIC MATERIALS is well known existing technology, mentioned in U.S. Pat. No. 6,443,521 B1 Nye et al Sep. 3, 2002 (C3/L28)

PIPE LEG REINFORCEMENT: a plastic insert that fits snugly inside a pipe leg and works to reinforce that leg, keeping it from bending. But also reinforcing that leg where hardware is installed, as in a channel, or a peg, for twist locking leg components. Rivets to hold the plastic insert. Such pipe reinforcement can also work to hold the hardware for swivel adjustable feet. (leg caps)

### A Final Note on Portation

While the JOUNEYCASE is fitted with a simple handle it is easily adapted to other means of possibilities include a side handle on the short side of the case, this to make it more comfortable to carry in crowds, a shoulder strap, back straps. It might even be fitted with two detachable or fixed wheels and an extendable handle as is popular these days in airports, or in a larger version simple roll on four such detachable wheels behind a short pull or leash.

There are also many ways to hold and keep detached legs when not in use, many ways in which the two halves of the case can connect and disconnect, many ways the case can lock and unlock, many ways it can be carried, say by a handle or a strap, or pulled by a retractable bar rip and rolled as is popular in traveling luggage these days

Note that while a pedestal hole is used in every case to fix the seat because it is so efficient and workless, there are many other ways to so fix the seat and the table top together so as to win the stability such connection affords. People who are uncomfortable “breaking” the seat case seek other means of connecting the table to the seat so that the seat supports it. the seat to support the table from attaching the pedestal support to the seat are welcome to all manner of other solution possibly but not limited to pedestal nose type approaches.

1-8. (canceled)

10. a table and seat that disassemble and come together to make an enclosed case, briefcase sized or larger

11. a table and seat as in claim 10 in which there is room inside said case for all the parts necessary to assemble and disassemble said table and seat.

12. a table and seat as in claim 11 in which there is room for other materials, some examples being a lap top computer and other work related equipment and/or materials, examples being medical, research or military equipment; art and/or craft supplies including calligraphy and fly tying equipment; audio visual presentation equipment: a P.A. and or recording equipment; lunch.

13. a table and seat as in claim 11 in which the table has at least 2 legs, one of which connects to the seat.

14. a table and seat as in claim 13 in which the distance between the seat and the table is adjustable.

15. a table and seat as in claim 13 in which the back legs of the table adjust so as to move table top work surface from a flat position to a position slanted toward the sitter.

16. a table and seat as in claim 13 in which the table on the sitters side is supported by a single central support that connects to the front also centrally such that the sitter straddles the support when seated.

17. a table and seat as in claim 16 in which the distance between the seat and the table is adjustable.

18. a table and seat as in claim 16 in which the back legs of the table adjust so as to raise the table top from a flat position to a position slanted toward the sitter.

19. a means of quickly attaching and detaching a leg from a leg receptacle whereby:
a) the leg receptacle consists of a mounting bracket and a leg housing which works to selectively fix a leg, said leg housing comprised of a tube shaped leg recess of interior diameter equivalent to the external diameter of the leg.
b) said leg receptacle has a spring held lever externally mounted to said leg housing. Said spring held lever has a button at one end that fits into a hole in the leg housing, and through that hole, a hole in the leg. A spring works to hold the button side of the level against the leg housing, and so the button in the hole placed in said housing to accommodate it.
c) a hole in the side of the leg so positioned to align with the hole in said leg housing receives the button catch when the leg is fully inserted into its leg housing.
d) a spring on said lever works to hold the button in position so as to lock said leg in said leg housing, or with pressing on said lever, to release it.

20. a mechanism as described in claim 19, in which a leg and an extension leg are selectively engaged.
a) the extension leg has at least two holes in series that the button catch on the original leg engages
b) the holes are placed such that the extension leg is recessed in one position, and variably extended in others.

21. a means of quickly attaching and detaching a furniture leg to furniture via a leg receptacle whereby
a) a leg of certain external diameter fits closely into a leg housing of same or near same interior diameter.
b) said leg receptacle has, in addition to said fitted leg housing, a lever operated cam nut clamp positioned such that with the leg inserted into said leg housing, said clamp by means of a simple motion of the cam nut lever works to fix said leg into said leg receptacle, or, once fixed, to release it.

22. a means as in claim 21 whereby leg height may be subtly adjusted to stabilize a portable work station on an uneven surface.

23. A means as in claim 21 whereby the back of the table can be lifted by leg extension so as to slant toward the sitter.

23. a means of stabilizing a series of free standing components by way of partly flexible connections between said components.

24. a means as in claim 23 whereby the flexibility of said connection is horizontal, or vertical, or both.

25. a means as in claim 23 whereby a portable combination table and seat unit, lacking the weight of the sitter, is stabilized.
